(19) United States
(12) Patent Application Publication
(10) Pub. No.: US 2014/0040767 A1
(43) Pub. Date: Feb. 6, 2014

(54) SHARED DIGITAL WHITEBOARD

(71) Applicant: Priyank Bolia, Udaipur (IN)

(72) Inventor: Priyank Bolia, Udaipur (IN)

(73) Assignee: Oracle International Corporation, Redwood Shores, CA (US)

(21) Appl. No.: 13/565,800

(22) Filed: Aug. 3, 2012

(51) Int. Cl. G06F 3/14

(52) U.S. Cl. 715/751

(57) ABSTRACT

An aspect of the present invention provides a peer-to-peer communication between source and target boards of a shared digital whiteboard. In one embodiment, a first system executing a first browser displaying a first web page containing a source board of the shared electronic whiteboard sends multiple packets (over a network) to a second system executing a second browser displaying a second web page containing a peer/target board of the shared electronic board, with each sent packet having a network destination address set to an IP address of the second system, the multiple packets specifying a content of the source board. The second system receives the multiple packets and reproduces the content in the target board.

### BACKGROUND OF THE INVENTION

1. Technical Field

The present disclosure relates to collaboration systems, and more specifically to shared digital whiteboards.

2. Related Art

A digital whiteboard refers to a technology in which a user at a first digital system can write/draw desired content and the same content is displayed at a second digital system. The first digital system at which the content originates is referred to as a source board and the second digital system at which the content is reproduced is referred to as a target board, of the (shared) digital whiteboard.

Digital whiteboards may need to be implemented to meet one or more of requirements such as enhanced availability of the technology on many systems, low bandwidth usage on a path connecting the source and target boards, user-friendliness, etc.

### BRIEF DESCRIPTION OF THE DRAWINGS

Example embodiments of the present invention will be described with reference to the accompanying drawings briefly described below.

FIG. 1 is a block diagram illustrating an example environment (computing system) in which several aspects of the present invention can be implemented.

FIG. 2 is a flowchart illustrating the manner in which a shared digital whiteboard is implemented according to several aspects of the present invention.

FIG. 3 illustrates an example user interface for a shared digital whiteboard provided according to several aspects of the present invention.

FIG. 4 is a block diagram illustrating the details of a digital processing system in which several aspects of the present invention are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### 1. Overview

An aspect of the present invention provides a peer-to-peer communication between source and target boards of a shared digital whiteboard. In one embodiment, a first system executing a first browser displaying a first web page containing a source board of the shared electronic whiteboard sends multiple packets (over a network) to a second system executing a second browser displaying a second web page containing a peer/target board of the shared electronic board, each sent packet having a network destination address set to an IP address of the second system, the multiple packets specifying a content of the source board. The second system receives the multiple packets and reproduces the content in the target board.

By providing a peer-to-peer communication between source and target boards using standard technologies such as HTML5 (well known in the arts), the digital whiteboards are made available on many disparate systems.

According to another aspect of the present invention, when the content is a drawing on a source board, the drawing being represented by multiple coordinates in the form of corresponding data elements, the first/source system performs a compression of only the data elements to form a compressed data and sends only the compressed data to the second/target system.

According to one more aspect of the present invention, the source system performs character recognition of the drawing on the source board to identify a set of characters, and then sends the characters along with uncompressed/compressed data elements corresponding to the multiple coordinates representing the drawing.

According to yet another aspect of the present invention, when the content is a pre-defined shape on a source board, the source system sends only an identifier of the pre-defined shape and corresponding attributes of the shape (as provided by the user using the source board) to the target system. The target system reproduces the pre-defined shape on the target board based on the received identifier and attributes. Examples of pre-defined shapes are geometrical shapes having dimension attributes, texts having attributes such as font style, font size, text color, background color, etc. and images having attributes such as location, height, and width.

According to an aspect of the present invention, in the scenario that the content (provided on the source board) contains multiple sub-contents in the form of a set of pages, where the source board and the target board are designed to display only one of the set of pages at any time instance, the target system is designed to maintain the sub-content in each of the set of pages in a local storage associated with the target system. Thereafter, in response to the source system indicating that a previous page (with respect to a currently displayed page) is to be displayed, the target system retrieves a sub-content corresponding to the previous page from the local storage and provides the sub-content on the target board. Thus, the target system reproduces the previous page without receiving packets corresponding to the sub-content of the previous page from the first system.

According to another aspect of the present invention, in response to a user input in the source board indicating that action is to be performed on the source board, the source system sends an identifier specifying the action to the target system, such that the target system can reproduce the action in the target board. Examples of such actions are clearing the content displayed on the source board, undoing or redoing a previous action performed on the source board and recording a delay between user inputs provided on the source board.

It may be noted that according to several aspects of the present invention, only the data required for reproducing the source board is sent to the target board and accordingly the bandwidth usage on the path connecting the source and target systems is reduced.

Several aspects of the present invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### 2. Example Environment

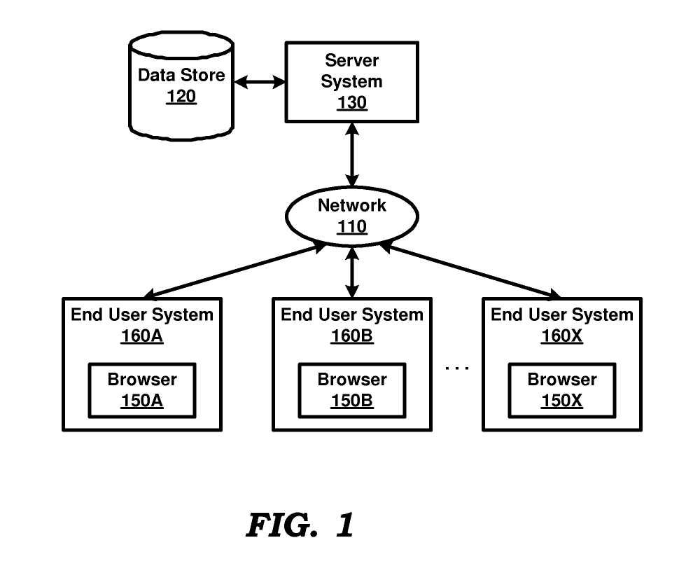

FIG. 1 is a block diagram illustrating an example environment (computing system) in which several aspects of the present invention can be implemented. The block diagram is shown containing network 110, data store 120, server system 130 and end user systems 160A-160X (each of which in turn is shown containing respective one of browsers 150A-150X).

Merely for illustration, only representative number/type of systems is shown in FIG. 1. Many environments often contain many more systems, both in number and type, depending on the purpose for which the environment is designed. Each system/device of FIG. 1 is described below in further detail.

Network 110 provides connectivity between server system 130 and end user systems 160A-160X, and may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the target system to which the packet is to be eventually delivered. An IP packet is said to be directed to a target system when the destination IP address of the packet is set to the IP address of the target system, such that the packet is eventually delivered to the target system by Internet 120 and intranet 130. When the packet contains content such as port numbers, which specifies the target application (such as browser 150A-150X), the packet may be said to be directed to such application as well.

Data store 120 represents a non-volatile (persistent) storage facilitating storage and retrieval of data by applications executing in server system 130. Data store 120 may be implemented as a corresponding database server using relational database technologies and accordingly provide storage and retrieval of data using structured queries such as SQL (Structured Query Language). Alternatively, data store 120 may be implemented as a corresponding file server providing storage and retrieval of data in the form of files organized as one or more directories, as is well known in the relevant arts.

Server system 130 represents a server, such as a web/application server, executing applications (e.g., those facilitating digital whiteboards, as described below) capable of performing tasks requested by users using one of end user systems 160A-160X. A server system may use data stored internally, external data maintained in data store 120 or that received from external sources (e.g., from the user) in performing such tasks. The server system then sends the result of performance of the tasks to the requesting end user system (one of 160A-160X).

Each of end user systems 160A-160X represents a system such as a personal computer, workstation, mobile station, mobile phones (such as iPhone™ available from Apple corporation, any smart pone operating using the Android™ operating system available from Google Corporation), computing tablets, etc., used by users to generate (server) requests directed to applications executing in server system 130. The requests may be generated using appropriate user interfaces. In general, an end user system requests an application for performing desired tasks and receives corresponding responses containing the results of performance of the requested tasks. Each server request is sent in the form of an IP packet directed to the desired server system (and application), with the IP packet including data identifying the desired tasks in the payload portion.

Each of browsers 150A-150X represents an application (executing in the corresponding end user systems 160A-160X) which enables users to access various content (such as audio, video, text, data, etc.) provided by server system 130, using standard protocols such as HTTP, as is well known in the relevant arts. The content is received generally in the form of respective web pages, and presented (played, displayed, etc.) to users. The desired web pages are accessed by specifying the corresponding universal resource locators (URLs) associated with the web pages. Examples of browsers include Internet Explorer™, Firefox™, and Chrome™ applications.

In one prior approach, a shared digital whiteboard is implemented as an application executing in server system 130. The whiteboard server application is designed to provide various source/target boards in the form of web pages, in particular, based on technologies (such as Flash files, Java™ applets, etc.) capable of execution within a browser. As such, a user wishing to provide content uses one of the browsers (for example, 150A) to access a source board web page provided by the whiteboard server application. Other users wishing to access/share the source board are required to access and display the target boards using corresponding browsers (one of 150B-150X). The content originating on the source board is sent in the form of IP packets to whiteboard server application (executing in server system 130), which in turn forwards the packets to the end user systems displaying the target whiteboards.

One drawback with such a prior approach is that source and target boards are required to interact with each other through a server system (130). Another drawback is that the implementation of source and target boards using browser based technologies requires installation of additional software (other than the browser) such as Flash Player available from Adobe Corporation (for execution of Flash files) or Java Virtual Machine (JVM) available from Oracle Corporation (for execution of Java™ applets). Such requirement of additional software may present impediments in the implementation of digital whiteboards on disparate systems such as mobile devices, tablets, laptops, net books, etc., having different operating systems.

One more drawback to the prior approach is the high bandwidth requirements for sharing digital whiteboards, in particular, among a large number of users. In one embodiment, the content of the shared board is sent/received in the form of images (possibly forming a video), each image capturing the state of the whiteboard at a corresponding time instance. The images are typically sent at regular time intervals (say, every second), to ensure that any updates to the source board are reproduced on the target boards. Such transmission of images (even when compressed) necessitates a larger amount of data to be sent over the network.

It may be accordingly be desirable to implement shared digital whiteboards that overcome at least some of the drawbacks noted above. Several aspects of the present invention facilitate the implementation of such shared digital whiteboards, as described below with examples.

### 3. Peer-To-Peer Digital Whiteboard

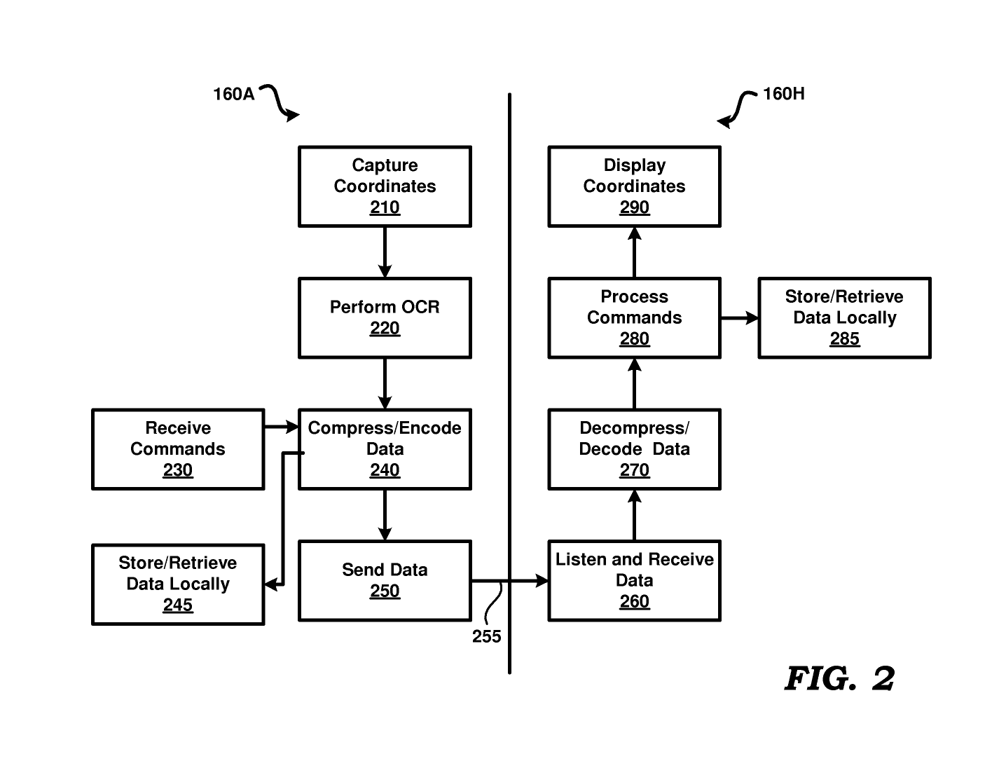

FIG. 2 is a flowchart illustrating the manner in which a shared digital whiteboard is implemented according to several aspects of the present invention. Steps 210, 220, 230, 240, 245 and 250 are shown performed at a source board/system, while steps 260, 270, 280, 285 and 290 are shown performed at a target board/system. Each of the steps is described in detail below.

For illustration, the source board is assumed to be provided by browser 150A in end user system 160A and the target board is assumed to be provided by browser 150H in end user system 160H. In other words, the corresponding board provided in the form of a respective web page, is presented/displayed by the respective browser 150A/150H. However, other source/target boards (including multiple target boards) may be similarly provided on other end user systems, as will be apparent to one skilled in the relevant arts by reading the disclosure provided herein.

An aspect of the present invention facilitates the source and target systems (160A and 160H) to interact with each other directly, without going through a server system (such as 130). In other words, the source system sends one or more packets specifying the content of the source board (via path 255) to the target system, with each packet having a network destination address set to an IP address of the target system (on network 110). The packets are accordingly delivered (by network 110) directly to the target system. Similarly, packets sent from the target system specify the IP address of the source system to cause the packets to be delivered directly (i.e., without server system 130 having to process the packets) to the source system. It should be noted that the web paged containing the digital whiteboards are initially downloaded from server system 130, but once downloaded resides in end user systems 160A/160H (for example, in an application cache) for all future purposes.

Accordingly, the end user systems may be viewed as forming a peer-to-peer network with the source and target boards viewed as being “peer” boards. In the following description, the term “peer board” is used to refer to target boards that reproduce the content originating (where drawn/input by a user) on a source board. In one embodiment, peer-to-peer communication (via path 255) between the source board in end user system 160A and the peer board in end user system 160H is implemented using WebSockets described in detail below.

WebSocket refers to a network technology for providing bi-directional, full-duplex communication channels over a single TCP connection. More details on the WebSocket protocol is described in RFC 6455 entitled, “The WebSocket Protocol”. The WebSocket technology also provides an Application Programming Interface (API) for creating “socket” connections between a web browser and a server (or another web browser). The established communication channel is persistent between the client and the server and both users can start sending data at any time. More details on the WebSockets API (which facilitates the browser-to-browser communication) provided as part of HTML5 is available from World Wide Web Consortium (W3C) located at W3C/MIT, 32 Vassar Street, Room 32-G515, Cambridge, Mass. 02139, United States.

A sample implementation (using HTML5 and Javascript™) of peer-to-peer communication between end user systems using the WebSocket API of HTML5 is shown below:

```
<!DOCTYPE html>
<meta charset=“utf-8” />
<title>WebSocket Test</title>
<script language=“javascript” type=“text/javascript”>
  var wsUri = “ws://echo.websocket.org/”;
  var output;
  function init( ) {
  output = document.getElementById(“output”);
  testWebSocket( );
  }
  function testWebSocket( ) {
  websocket = new WebSocket(wsUri);
  websocket.onopen = function(evt) { onOpen(evt) };
  websocket.onclose = function(evt) { onClose(evt) };
  websocket.onmessage = function(evt) { onMessage(evt) };
  websocket.onerror = function(evt) { onError(evt) };
  }
  function onOpen(evt) {
  writeToScreen(“CONNECTED”);
  doSend(“WebSocket rocks”);
  }
  function onClose(evt) {
  writeToScreen(“DISCONNECTED”);
  }
  function onMessage(evt) {
  writeToScreen(‘<span style=“color: blue;”>RESPONSE: ’ +
  evt.data+‘</span>’);
  websocket.close( );
  }
  function onError(evt) {
  writeToScreen(‘<span style=“color: red;”>ERROR:</span> ’ +
  evt.data);
  }
  function doSend(message) {
  writeToScreen(“SENT: ” + message);
  websocket.send(message);
  }
  function writeToScreen(message)  {
  var pre = document.createElement(“p”);
  pre.style.wordWrap = “break-word”;
  pre.innerHTML = message;
  output.appendChild(pre);
  }
  window.addEventListener(“load”, init, false);
</script>
<h2>WebSocket Test</h2>
<div id=“output”></div>
</html>
```

It should be noted that the IP addresses of the source and target systems may be communicated to each other in any convenient manner. In one embodiment, a user downloads the web page containing the electronic whiteboard from server system 130, initializes a source board of the electronic whiteboard and then registers the IP address of the source system with server system 130 (along with a unique identifier identifying the source board). Accordingly, when the web page is downloaded (based on the unique identifier) from server system 130 by the target systems for initializing the peer/target boards, the IP addresses of the source system is also made available (for example, as part of the web page) to the target systems.

Alternatively, the target systems may be designed to dynamically (after the web page providing the target board is displayed prior to initialization of the source board) request server system 130 for the IP addresses of the source system. For example, the IP address of the source system is provided by a web service served by server system 130, with the target systems designed to retrieve the IP address using the web service (for example, based on the name of the source system, the name of the end user or a unique identifier generated for the source board). In another embodiment, the source system IP address is sent to the target systems as part of a message such as email, short message service (SMS) message, instant messaging (IM) message, etc.

After retrieving the IP address of the source system, the target systems may connect to the source system using technologies such as WebSockets, as described in detail above. In particular, a target system establishes a communication channel with the source system using the source system IP address, and then provides its own (target) IP address to the source system. The source system thereafter sends the packets (containing the input data) directed to the target IP addresses of the target systems.

Thu, the peer-to-peer digital whiteboard described above uses the server system only for identifying the IP addresses of the source/target systems. All packets specifying the content of the source board are thereafter sent directly to the target systems using the communication channels provided by WebSockets, without going through the server system.

In one embodiment, the shared electronic whiteboard is implemented using HTML5 and Javascript, as one or more code/executable modules constituting a web page. The web page when download and loaded/displayed in a browser (causing execution of the modules) provides several features of the invention described below. The modules are executed in the context of the browser implying that the modules are allowed access to only those system resources (e.g., CPU time, memory, etc.) that are accessible to the browser, as is well known in the relevant arts.

It may be appreciated that HTML5 and Javascript are standards that are implemented (and is made available) within browsers, thereby avoiding the requirement to install additional software. Furthermore, the HTML5/Javascript standards are currently supported by disparate systems operating using different operating systems.

Thus, the peer-to-peer digital whiteboard facilitates enhanced availability of the technology on many disparate systems, while overcoming some of the drawbacks noted above. The description is continued illustrating the manner in which a peer-to-peer digital white board may be implemented with low bandwidth requirements.

### 4. Capturing and Sending Content

Referring back to FIG. 2, in step 210, source system 160A captures the coordinates of the drawing created by a user on the source board. In one embodiment, the display area in which a user is enabled to draw/view content (hereafter referred to as a “canvas”) is monitored for user inputs. In response to a user clicking/pressing the mouse down, drawing some shape (a geometric form having any number of points, lines, etc.) and releasing the mouse button, the coordinates (in the X and Y direction) of each point in the shape is identified.

For example, in response to a user drawing a shape, the following (X, Y) coordinates may be identified: (69, 241), (69, 242), (69, 244), (70, 245), (70, 248), (71, 252), (71, 257), (72, 263), (73, 268), (73, 273), (75, 279), (75, 284), (75, 291), (75, 294) and (75, 299). A user may similarly add one or more shapes as part of the drawing/content of the source board, with source system 160A capturing the coordinates of each shape created by the user. In one embodiment, the canvas is implemented using HTML5 Canvas element, described in detail in the book entitled “HTML5 Canvas—Native Interactivity and Animation for the Web” by Steve Fulton and Jeff Fulton (ISBN: 978-1-4493-9390-8).

The identified coordinates may be converted to any convenient representation such as XML, binary object, etc., for the purpose of storage, sending on the network, compression, etc. In one embodiment, the coordinates are converted to JSON (JavaScript Object Notation) format, which is described in detail in RFC 4627 entitled, “The application/json Media Type for JavaScript Object Notation (JSON)”. Thus, the above noted set of coordinates may be captured in JSON as {“shape”: {“coordinates”: {“x”:[69, 69, 69, 70, 70, 71, 71, 72, 73, 73, 75, 75, 75, 75, 75], “y”: [241, 242, 244, 245, 248, 252, 257, 263, 268, 273, 279, 284, 291, 294, 299]}}}.

According to an aspect of the present invention, only the captured coordinates are sent on the network (110) to the target system (in step 250). The coordinates may be sent as a text according to the JSON format noted above, as is well known in the arts. By sending only the coordinates of the shapes, the bandwidth requirements for sending to a large number of target boards is maintained low, at least in comparison to the prior approach where images capturing the state of the source board are sent.

In step 220, source system 160A performs an optical character recognition (OCR) on the captured coordinates, according to an aspect of the present invention. As is well known, OCR refers to the identification of textual characters (or symbols) from images (containing a corresponding handwritten, typed or printed textual drawing).

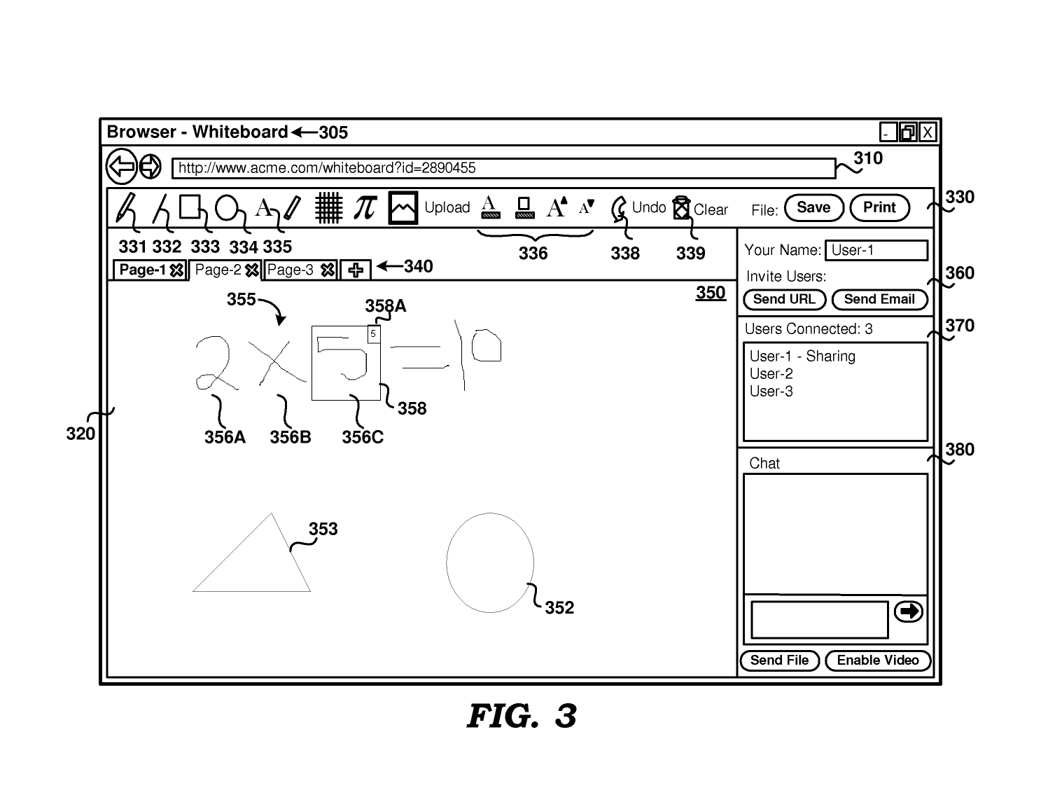

For example, the performance of OCR on drawing 355 (of FIG. 3) may result in the recognition of the character “2” corresponding to shape 356A, the symbol “x” corresponding to shape 356B, the character “5” corresponding to shape 356C, etc. Accordingly, the drawing 355 may be recognized as the text “2×5=10”. The recognized text may be displayed on the source/target boards, in addition to (as depicted in FIG. 3 for ‘5’) or replacing the drawings created by the user.

According to another aspect of the present invention, the set of characters (text) recognized corresponding to a drawing is sent on the network (110) to the target system (in step 250). The set of characters may be sent along with (or in place of) the drawings/shapes created by the user. The sending of the recognized characters may facilitate searching, storage and general understanding of the source images/drawings.

### 5. Receiving and Sending Commands

In step 230, source system 160A receives commands as user inputs, each command indicating a corresponding action to be performed on source board. The command may be received in the form of the user selecting a menu item/icon, clicking a button, entering a text, pressing a set of keys, etc. The non-receipt of any user inputs may also be viewed as a “delay” command, indicating that there is a delay between the performances of two actions/inputs.

In response to receiving a command, source system 160A performs the corresponding action on the source board (150A). The actions may relate to content creation such as adding a pre-defined shape, text or image to the canvas, to sending additional content such as audio/video clips, or to performing (system) actions on the source board such as clearing the canvas (that is the existing drawings/content displayed) on the source board, undoing or redoing a previous action performed on the source board, and recording a delay between user inputs provided on the source board.

According to several aspects of the present invention, source system 160A includes only an indication of the actions (corresponding to commands received from user) in the packets sent to the target system (in step 250). Thus, in response to adding a pre-defined shape, source system 160A sends an identifier specifying the pre-defined shape and attributes of the pre-defined shape, such that the target system can reproduce the pre-defined shape in the peer board (150H). The attributes of the pre-defined shape may be provided as user inputs along with the command (for example, by specifying the values in text fields) and/or in addition to the command (for example, using the mouse to specify locations on the canvas).

In a scenario where the pre-defined shape is a geometrical shape (such as line, circle, triangle, etc.) having one or more dimension attributes (such as length, radius, etc.), source system 160A may send an identifier of the geometrical shape and the values of the attributes to the target system. For example, in response to a user specifying a command to add a line with a specific dimension, the text {“line”: {“top”: 0, “left”: 0, “right”: 100, “bottom”: 0}} according to JSON format may be generated and sent to the target system. It may be observed that only the coordinates of the end points of the line (instead of the coordinates of all the points on the line) are being sent using the format noted above.

In a scenario where the pre-defined shape is a text, the actual set of characters entered by the user along with text attributes such as font style, font size, text color, and background color of the text are sent to the target system. The text and attributes may be sent as {“text”: {“X”: 300, “Y”: 200, “data”: “HTML 5 Whiteboard”}} according to JSON format. Similarly, when the pre-defined shape is an image having attributes such as location, height, and width, a text such as {“image”: {“X”: 0, “Y”: 0, “src”:https://secure.acme.com/avatar/?s=128&r=PG, “width”: 32, “height”: 24}} may be sent by source system 160A to target system 160H.

According to one aspect of the present invention, when the actions relate to sending additional content such as audio and/or video clips, source system 160A sends an identifier specifying the type of the clip and the attributes such as the encoding, location in the form of a URL (universal resource locator), etc. to the target system to enable the target system to reproduce the clip in the peer board. For example, source system 160A may send the text {“audio”: {“Encoding”: “MP3”, “Length”: 5000, “src”: “https://example.com/audio1.mp3”}} in response to a user specifying a command to play an audio file. It should be noted that audio files capturing the speech of the user, may also be sent in a similar manner (using any desired encoding technique such as MP3, Vorbis, OGG, etc. well known in the arts). The capturing of the speech of the user may be performed according to the details provided in the document entitled “HTML Media Capture” available from W3C organization, noted above.

According to another aspect of the present invention, source system 160A sends identifiers of system actions such as clearing, recording delay, etc. to the target system. For example, in response to a clearing action, the source system may send the text {“clear”: “#FFFFFF”} according to JSON format to the target system, where the value “#FFFFFF” indicates that the canvas is to be cleared with the background color white. In response to a delay action, the source system may send the text {“delay”: 5000}, where the value “5000” represents the recorded delay in milliseconds.

It should be appreciated that by sending such information in the form of identifiers and corresponding attributes/values, the bandwidth requirements are maintained low. In contrast, the sending of images in the prior approach would require additional bandwidth since all the points in the canvas are sent at each time instance (instead of only pre-defined shapes). Furthermore, the sending of images at regular intervals in the prior approach would also increase the bandwidth requirements, since images would be sent on the network even when not required (for example, during the delay period, or a blank image in the background color following a clear action

### 6. Compressing and Recording Data

In step 240, source system 160A compresses (and encodes) the data to be sent to the target systems. According to an aspect of the present invention, the compression is performed on the coordinates captured in step 210. In one embodiment, in response to user drawing a shape, the coordinates (in the form of data elements as shown above) of points forming the shape are captured and compressed using one of more compression techniques like Run Length Encoding, Huffman Encoding, LZW, etc. as will apparent to one skilled in the relevant arts. The data elements representing the coordinates are received from the canvas of the source board displayed by browser 150.

For example, the above noted set of coordinates {“shape”: {“coordinates”: {“x”:[69, 69, 69, 70, 70, 71, 71, 72, 73, 73, 75, 75, 75, 75, 75], “y”: [241, 242, 244, 245, 248, 252, 257, 263, 268, 273, 279, 284, 291, 294, 299]}}} according to JSON format may be compressed using delta/differential compressions as {“shape”: {“XPos”:69,“YPos”:241,“coordinates”:{“x”: [“0x3”, “1x2”, “1x2”, 1, “1x2”, “2x5”], “y”: [0, 1, 2, 1, 3, 4, 5, 6, 5, 5, 6, 5, 7, 3, 5]}}} where XPos and YPos are the starting X and Y values respectively, and each of entries in the coordinates array specifies the delta/difference with the previous value.

In particular, a simple number in the series indicates the difference with the previous value. In the representation “0x3”, the first number before the “x” indicates the difference, while the second number after the “x” indicates the number of times the current value is to repeated. Thus, the first “0x3” for the X coordinates indicates that the current value is previous value 69 (XPos)+0 (the first number)=69 and it is to be repeated 3 times (the second number). Similarly, the next “1x2” indicates that the current value 69 (previous value)+1 (the first number)=70 is to be repeated 2 times (the second number). Though the above described technique is a lossless compression, in alternative embodiments (or in addition), lossy data compression can also be used as will apparent to one skilled in the relevant arts.

The compressed coordinates may then be sent to the target system (via path 255), instead of sending the coordinates according to JSON format as noted above. It may be appreciated that the compressed format requires very less storage space and bandwidth, and as such provides an efficient manner of sending and displaying the content of shared digital whiteboards.

In step 245, source system 160A stores/retrieves from/to a local storage, the data elements representing the coordinates of the drawings on the source board, according to an aspect of the present invention. The local storage (though not shown in FIG. 1) is a part of source system 160A and provided by the browser as part of the HTML5 standard. By storing the coordinates of the drawings at different (and consecutive) time instances, a recording of the content drawn on the source board is generated. The coordinates may be stored associated with a respective time stamp to facilitate later reproduction of the recording (either at the source board or at target boards). An audio (capturing the voice of the user using the source board) may also be generated and stored as part of the recording.

It may be appreciated that by storing only the coordinates and associated time stamps, the size of the recording may be kept low (for example, 1-10 megabytes). In comparison in a prior approach, the size of the recording would be considerably big (for example, 100-200 megabytes) since the recording in prior approach necessitates storing of images (capturing the states of the source board) at different time instances. The recording may be stored in any convenient format such as files. It may be further appreciated that by capturing the recording (for later offline viewing) in a text based format such as JSON, compression of the captured data may be performed (using one of the compression techniques noted above), further reducing the size of the recording. Also, such textual data (either in compressed or uncompressed format) simplifies transmission and client side decoding by target browsers (such as 150H).

In one embodiment, the local storage is implemented using HTML5 Web SQL Database element, described in detail in the book entitled “Introducing HTML5” by Bruce Lawson and Remy Sharp (ISBN-13: 978-0-321-68729-6). Alternatively, the local storage can be implemented using HTML5 Indexed Database API, as described in detail in a document entitled “Indexed Database API” available from W3C organization, noted above.

An aspect of the present invention facilitates recording an animation of the user actions (similar to a video sequence). In one embodiment, actions performed by the user on a source board are captured along with any delay actions/commands between the user actions. The actions along with any delays between them is then stored (for example, according to JSON format) in a local storage either on the source or target systems. On receiving an indication that the stored recording is to be reproduced (either on the source or target boards), the stored actions and the corresponding stored delays between them are retrieved and reproduced on the boards, thereby producing an animation of the user actions.

In step 250, source system 160A sends data representing the inputs provided by the user on the source board to target systems (such as 160H executing browser 150H). The data may be the coordinates of a shape/drawing drawn by the user on the canvas, or the identifiers corresponding to commands specified by the user. The coordinates may be sent in JSON format without compressing, or may be sent after compression using the techniques noted above. Furthermore, the set of characters recognized by performing OCR (in step 220) may also be sent along with the coordinates.

The manner in which a target system may receive the data and reproduce the content and actions on a peer board is described below with examples. Though the description is continued with respect to a peer board provided by browser 150H executing in target system 160H, the features of the present invention may be similarly implemented in other target systems as well, as will be apparent to one skilled in the relevant arts by reading the disclosure herein.

### 7. Reproducing Content and Actions at a Peer Board

In step 260, target system 160H listens and receives data (representing the inputs provided at the source board) from source system 160A. As noted above, the packets containing the input data are received directly from source system 160A. Target system 160H may accordingly be designed to listen (check for packets) at a specific address (the IP address of the target system) and a pre-defined port number. As noted above, in one embodiment, target system 160H receives the data in the form of a text according to JSON format and processes the text to identify the elements specified according to the JSON format.

It may be appreciated that target system 160H may receive some of the packets from other systems (such as other end user systems) listening to the source system 160A for reproducing the content. Such relaying of packets is commonly used in peer-to-peer systems for reducing the bandwidth requirement of the source system 160A, taking advantage of the physical proximity (in terms of the number of intermediate network points) between the target systems and relaying systems, and using faster communication channels present between the source and the target systems.

In step 270, target system 160H decompresses (and decodes) the data received from the source system, if the received data is determined to be compressed (and encoded). When the received data is not compressed (for example, when the data is identifiers of actions, coordinates of shapes, etc.), no decompression may be performed in step 270. The decompression and decoding of the data may be performed in a known way, for example, by using the corresponding decompression techniques of the compression techniques noted above.

For the lossless compression technique described in detail above, target system 160H upon receipt of the text {“shape”:{“XPos”:69,“YPos”:241,“coordinates”:{“x”: [“0x3”, “1x2”, “1x2”, 1, “1x2”, “2x5”], “y”: [0, 1, 2, 1, 3, 4, 5, 6, 5, 5, 6, 5, 7, 3, 5]}}}, performs the decoding of the delta compressions (such a 1, “0x3”, etc.) specified for the X and Y coordinates to determine the uncompressed set of coordinates as (69, 241), (69, 242), (69, 244), (70, 245), (70, 248), (71, 252), (71, 257), (72, 263), (73, 268), (73, 273), (75, 279), (75, 284), (75, 291), (75, 294) and (75, 299).

In step 280, target system 160H processes the commands, in particular, the identifiers of the actions specified in the received data. For example, in response to receiving an identifier of a geometrical shape along with dimension attributes, target system 160H draws on a canvas of the peer board the corresponding geometrical shape of the received dimension. Thus, in response to receiving the data {“line”: {“top”: 0, “left”: 0, “right”: 100, “bottom”: 0}} according to JSON format, target system 160H draws a line starting from (0, 0) to (100, 0) on the canvas of the peer board. Similarly, on receiving data such as {“text”: {“X”: 300, “Y”: 200, “data”: “HTML 5 Whiteboard”}}, target system 160H prints the text “HTML 5 Whiteboard” starting from the coordinates (300, 200).

In the scenario that the identifiers specify a type of a clip to be played, target system 160H downloads the clip from the URL specified in the received data and plays the audio and/or video clip. In the scenario that an identifier of a system action such as clear is received, target system 160H performs the corresponding system action on the peer board. Thus, the commands received at the source board of source system 160A is reproduced at the peer board of target system 160H.

In step 285, target system 160H stores/retrieves from/to a local storage, the data elements representing the coordinates of the drawings on the source board, according to an aspect of the present invention. The local storage (though not shown in FIG. 1) is a part of target system 160H. As such, target system 160H also generates a recording of the content of the source board on its local storage.

In one embodiment, the content (drawings) of the source board contains multiple sub-contents in the form of a set of pages. The source board and the peer boards are designed to display only one (referred to as the “current” page) of the set of pages at any given time instance. Both the source system 160A and target system 160H store a recording/current state of the sub-contents/pages in the respective local storage.

According to an aspect of the present invention, in response to receiving an indication (from source system 160A) that a previous page (not the current page) is to be displayed, target system 160H retrieves a sub-content corresponding to the previous page from the local storage and provides the sub-content on the peer board. The indication may be provided by source system 160A in response to a user indicating that the previous page is to be displayed (for example, by selecting the previous page from a selection field, by selecting a tab corresponding to the previous page, etc.). It may be noted, that only the page change command goes from the target system to the client system and not the actual contents of the page. The actual contents of the page are displayed from the client local storage.

It should be appreciated that the previous page is reproduced on the peer board of target system 160H without receiving packets corresponding to the sub-content from source system 160A, thereby further reducing the bandwidth requirements. The above described technique may be used to implement other features such as undoing or redoing a previous action on the source and peer boards. For example, in response to a redoing action, the target system may retrieve the shape/drawing corresponding to the previous action and display the retrieved shape/drawing on the peer board (without receiving the coordinates again from the source board).

In step 290, target system 160H displays shapes (corresponding to the received coordinate's data) on the canvas of the peer board. The coordinates may correspond to the coordinates of the user specified shape (received in JSON format either compressed or uncompressed) determined in step 270, to the coordinates of the geometric shape, text or image specified by identifiers in the received data (as processed in step 280) and/or to the coordinates of sub-content/shapes retrieved from the local storage (in step 285).

Thus, a peer board provided by browser 150H in target system 160H reproduces the content (and actions performed) on the source board provided by browser 150A in source system 160A. The description is continued illustrating an example user interface for the shared digital whiteboard described above.

### 8. Sample User Interface of a Digital Whiteboard

FIG. 3 illustrates an example user interface for a shared digital whiteboard provided according to several aspects of the present invention. Display area 300 depicts a portion of the user interface displayed on a display unit (not shown) associated with a source (such as 160A). Display area 300 is provided as a source board by browser 150A executing in source system 160A.

As noted above, the source whiteboard is provided in the form of a web page by server system 130 (in response to a user sending a server request from source system 160A). Alternatively, if the web page was already downloaded from server system 130, the source whiteboard may be loaded from a local cache (such as an application cache according to HTML5 standard) in source system 160A storing the downloaded web page. Browser 150A, in response to receiving the web page from server system 130, presents/displays the received web page to the user. Thus, display area 305 indicates that the current web page being displayed in display area 300 is titled “Whiteboard”, while display area 310 indicates the URL associated with (and used to access) the whiteboard web page.

Display area 320 depicts a portion of the whiteboard displayed by browser 150A (in response to URL shown in display area 310). Display area 320 is shown containing various graphical elements that facilitate a user to draw/write desired content on the whiteboard. Each of the graphical elements is described in detail below.

Toolbar 330 provides the user with various input/output elements (such as icons, buttons, menus, etc.) corresponding to different actions that may be performed using the whiteboard. For example, a user may click on pen icon 331 (and then use the mouse on canvas 350) to draw a free form line, on shape icons 332-334 to add corresponding pre-defined shapes (line, square, circle, etc.) to the HTML5 canvas used in the whiteboard, on text icon 335 to add text and then on format icons 336 to format (specify the font, the color, etc. of) the text, on undo icon 338 to undo the previous action performed and on clear icon 339 to clear the current page on the whiteboard (to a specific background color chosen using format icons 336).

Source system 160A receives commands corresponding to the user clicked icons in toolbar 330, and sends corresponding identifiers and attributes to the target systems (such as 160H). For example, source system 160A receives commands indicating pre-defined geometric shapes in response to user clicking on shape icons 332-334, commands indicating text in response to text icon 335 and format icons 336, and commands indicating system actions in response to user clicking on undo icon 338 and clear icon 339.

It should be noted that the source board also performs the actions corresponding to the commands on the source board. Thus, in response to the user first clicking on circle icon 334 and then selecting a point on canvas 350, source system 160A draws a circle with the selected point as the circle's center, as shown by shape 352 in canvas 350. A similar action may be performed on the canvas in the peer board by target system 160H in response to processing (in step 280) of the identifiers sent (according to JSON format) in the packets to the target system.

Tabs 240 facilitate a user to create multiple pages containing different sub-contents. As such, each of tabs labeled “Page-1”, “Page-2”, and “Page-3” represents a page containing corresponding user provided sub-content. A user may click on the tab labeled “+” to add a new page, and click on “x” on each of the tabs to remove the corresponding page. The tab “Page-2” is shown selected to indicate that the user is providing content for page 2 (the current page).

It may be appreciated that some of the whiteboards may be stripped down version without containing all the features noted herein, or have a different layout from that shown in FIG. 3 according to the device (mobile phone, desktop, etc.) and the resolution/orientation of the physical screen (in the display unit associated with source/target systems). On such stripped down versions, there may be no tabs and a page change command may cause loading of the corresponding page data from the local storage in the same display area (350).

Assuming that the user has already provided the sub-content for page 1, in response to a user selecting the tab “Page-1”, source system 160A sends an indication to target system 160H to display the previous page (page 1). Source system 160A retrieves the content of page 1 from the local storage or cache (stored in step 245) and displays the content in canvas 350. The tab “Page-1” is shown selected to indicate that page 1 is the current page. At the target system 160H, in response to the indication received from the source system, the content of page 1 stored in the local storage (in target system) is retrieved in step 285 and the corresponding content displayed on the canvas of the peer board (similar to that shown in 350).

Canvas 350 displays the content written/drawn by a user in response to corresponding inputs provided by the user. The user inputs may be provided using input devices such as a mouse and/or a keyboard, stylus or a digitizer. Thus, in response to a user selecting pen icon 331 and then moving the mouse while pressing the left mouse button or a key on a keyboard, a corresponding (free form) shape such as shape 356A may be displayed in canvas 350 corresponding to the motion of the mouse (within the boundary of the canvas). A user may similarly create other shapes such as 356B and 356C using the mouse to create the drawing 355.

Source system 160A may perform OCR on drawing 355 to recognize the set of characters corresponding to the shapes in the drawing. Thus, in response to performing the OCR, source system 160A may recognize the set of characters “2×5=10” corresponding to drawing 355. Though not shown, the user may be provided an option to replace drawing 355 with the recognized text.

According to an aspect of the present invention, source system (160A) identifies/recognizes that a first portion (shape 356C) of the drawing (355) represents a first character and then displays the first character associated with the first portion in the source board (as shown by box 358). It may be observed that the recognized character “5” is shown as a suggestion within display area “358A” of box 358.

In the scenario that the user clicks on display area 358A, source system 160A replaces the user drawn shape (356C) with the recognized character “5”. Such a feature may be desirable for some pictorial languages like Chinese, Japanese to provide better understanding for the users (creating and viewing the content). Alternatively, source system 160A is designed to perform the replacement if no cancel action is received in a pre-determined duration (for example, 45 seconds).

In one embodiment, the user selects/accepts the suggestion by single clicking display area 358A and performs the cancel action by double clicking the same display area 358A. Thus, if the user does not double click display area 358A within the pre-determined duration, the source system replaces the shape with the recognized character. In alternative embodiments, the source system may perform the replacement after the pre-determined duration only if the shape has been recognized with accuracy greater than a threshold (such as 85%).

As noted above, canvas 350 may also display pre-defined shapes (such as circle 352) in response to a user selecting the circle icon 334 and then selecting a point on the canvas. In addition, source system 160A may determine that a user has specified a pre-defined shape based on user inputs. For example, in response to a user drawing three lines (for example, by clicking line icon 332 and then selecting two points on canvas 350) as shown by shape 353, source system 160A determines that a triangle shape has been drawn. Source system 160A may accordingly send a text such as {“triangle”: {“X1”: 45, “Y1”: 50, “X2”: 83, “Y2”: 95, “X3”: 107, “Y2”: 54}} instead of sending the details of three lines separately.

In one embodiment, source system captures the pre-defined shapes along with any delays (commands) received between them as a recording of the user actions. Thus, in a scenario that the user first draws circle 352 on canvas 350, waits for 10 seconds, and then draws triangle 353 on canvas 350, the source system captures the text {“set1”: {“circle”: {“X”: 144, “Y”: 50, “radius”: 25}}, {“delay”: 10000}, {“triangle”: {“X1”: 45, “Y1”: 50, “X2”: 83, “Y2”: 95, “X3”: 107, “Y2”: 54}}}. The actions may be stored as a recording in a local storage on the source or target systems, and may be later reproduced on the source/target boards. As such during reproduction, the source/target system may first draw the circle (352) and then wait for 10 seconds before drawing the triangle (353), thereby reproducing the recording of the user actions

Display area 360 facilitates a user to specify his/her name (shown to be “User-1”) and also to invite other users to share (that is, to view the contents of) the whiteboard. The invitation may be sent in the form of an URL, or in chat message or an email to the other user. Display area 370 displays the total number and names of users (respectively 3 and “User-1”, “User-2”, “User-3”) that are currently connected and viewing the whiteboard. Display area 370 further indicates (by the text “- Sharing”) that User-1 is sharing his/her whiteboard with other users, that is, the whiteboard shown in display area 300 represents a source board whose content is reproduced in the target boards of the end user systems used by User-2 and User-3.

Display area 380 facilitates users to chat with each other, for example, by sending text messages or by video using the “Enable Video” button. The “Send File” button in display area 380 facilitates users to share content such as text, audio or video files. In response to a user clicking on the “Send File” button, source system 160A may provide an additional interface (for example, as a pop up window) for receiving the attributes such as the type (audio, video or a combination thereof), the encoding, the URL, etc. of the clip. Source system 160A then sends an identifier specifying the type and other attributes to the target systems.

Thus, a user “User-1” is facilitated to write/draw content and perform actions on source digital whiteboard 200 and to share the content and actions with other users such as “User-2” and “User-3” (using corresponding peer boards). Though the features of the present invention are described with respect to a source board in source system 160A, it should be appreciated that the features may be implemented in any digital processing system (such as end user systems 160B-160X). The peer boards may be provided similar to display area 300 (with less or more of the graphical elements described herein).

It should be further appreciated that the features described above can be implemented in various embodiments as a desired combination of one or more of hardware, executable modules, and firmware. The description is continued with respect to an embodiment in which various features are operative when corresponding executable modules are executed.

### 9. Digital Processing System

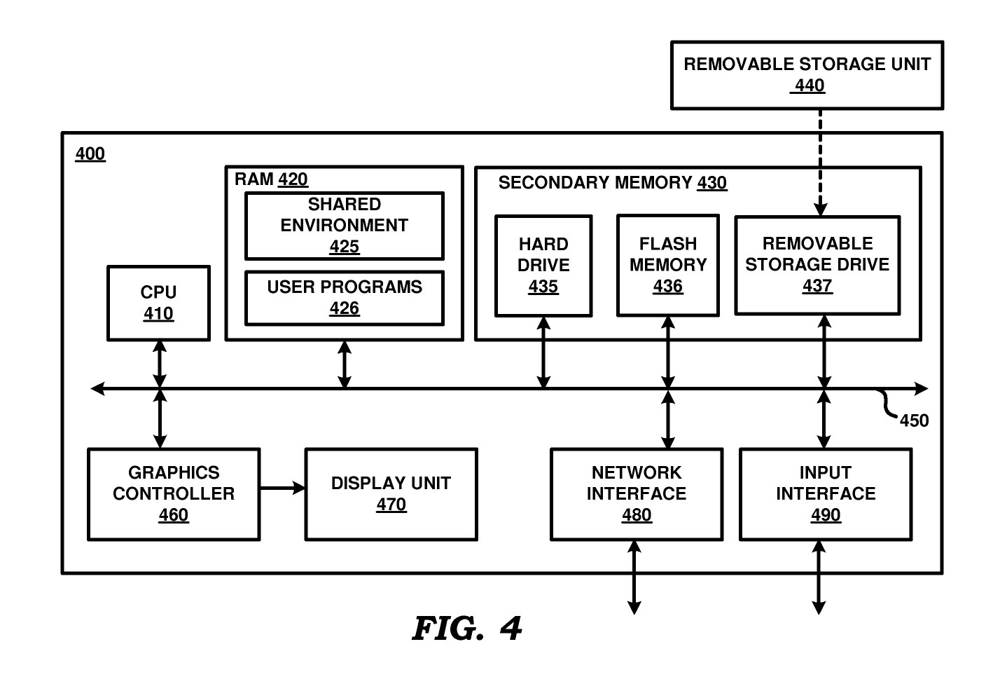

FIG. 4 is a block diagram illustrating the details of digital processing system 400 in which several aspects of the present invention are operative by execution of appropriate executable modules. Digital processing system 400 may correspond to any one of end user systems 160A-160X.

Digital processing system 400 may contain one or more processors (such as a central processing unit (CPU) 410), random access memory (RAM) 420, secondary memory 430, graphics controller 460, display unit 470, network interface 480, and input/output interface 490. All the components except display unit 470 may communicate with each other over communication path 450, which may contain several buses as is well known in the relevant arts.

CPU 410 may execute instructions stored in RAM 420 to provide several features of the present invention. CPU 410 may contain multiple processing units, with each processing unit potentially being designed for a specific task. Alternatively, CPU 410 may contain only a single general-purpose processing unit. The execution of such instructions may provide each of browsers 150A-150X.

RAM 420 may receive instructions from secondary memory 430 using communication path 450. RAM 420 is shown currently containing software instructions constituting shared environment 425 and/or user programs 426. Shared environment 425 contains utilities shared by user programs, and such shared utilities include operating systems, virtual machines, etc., which provide a (common) run-time environment for execution of applications (such as browsers 150A-150X).

Graphics controller 460 generates display signals (e.g., in RGB format) to display unit 470 based on data/instructions received from CPU 410. Display unit 470 contains a display screen to display the images defined by the display signals (for example, portions of the user interface shown in FIG. 3). Input/output interface 490 includes input as well as output devices to enable a user to interact with system 400 (for example, to interact with the user interface of FIG. 3). Network interface 480 provides the physical, electrical and protocol implementations that enable system 400 to communicate with other systems using protocols such as TCP/IP.

Secondary memory 430 (representing a non-transitory storage/medium) may contain hard drive 435, flash memory 436, and removable storage drive 437. Secondary memory 430 may store data and software instructions (for example, for performing the steps of FIG. 2), which enable digital processing system 400 to provide several features in accordance with the present invention, as described above.

Some or all of the data and instructions may be provided on removable storage unit 440, and the data and instructions may be read and provided by removable storage drive 437 to CPU 410. Floppy drive, magnetic tape drive, CD-ROM drive, DVD Drive, Flash memory, removable memory chip (PCMCIA Card, EPROM) are examples of such removable storage drive 437.

Removable storage unit 440 may be implemented using medium and storage format compatible with removable storage drive 437 such that removable storage drive 437 can read the data and instructions. Thus, removable storage unit 440 includes a computer readable storage medium having stored therein computer software and/or data. However, the computer (or machine, in general) readable storage medium can be in other forms (e.g., non-removable, random access, etc.).

In this document, the term “computer program product” is used to generally refer to secondary memory 430. These computer program products are means for providing software to digital processing system 400. CPU 410 may retrieve the software instructions, and execute the instructions to provide various features of the present invention described above.

It should be understood that numerous specific details, relationships, and methods are set forth to provide a full understanding of the invention. For example, many of the functions units described in this specification have been labeled as modules/blocks in order to more particularly emphasize their implementation independence.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

### 10. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A computing system providing a shared electronic whiteboard, said computing system comprising:
a first system executing a first browser, said first browser displaying a first web page containing a source board of said shared electronic whiteboard; and
a second system executing a second browser and coupled to said first system by a network, said second browser displaying a second web page containing a peer board of said shared electronic board,
wherein said first system sends a plurality of packets to said second system, wherein each packet has a network destination address set to an IP address of said second system, said plurality of packets specifying a content of said source board,
said second system to receive said plurality of packets and to reproduce said content in said peer board.

2. The computing system of claim 1, further comprising a server system to serve said first web page to said first system, and said second web page to said second system, wherein said server system incorporates another IP address of said first system in said second web page,
wherein said second system establishes a communication channel with said first system using said another IP address, wherein said IP address of said second system is provided to said first system after said communication channel is established,
wherein said first system sends said plurality of packets over said communication channel.

3. The computing system of claim 2, wherein said content comprises a drawing on said source board, said drawing being represented by a plurality of coordinates in the form of corresponding data elements,
wherein said first system performs a compression of only said data elements to form a compressed data, said compressed data being sent in said plurality of packets.

4. The computing system of claim 3, wherein said data elements are received from said first browser before being compressed.

5. The computing system of claim 2, wherein said content comprises a drawing on said source board at a time instance, said drawing being represented by a plurality of coordinates in the form of corresponding data elements,
wherein said first system generates a recording of said content comprising said data elements associated with said time instance.

6. The computing system of claim 5, wherein said content further comprises a second drawing on said source board at a second time instance, said second drawing being represented by a second plurality of coordinates in the form of corresponding second set of data elements,
wherein said recording of said content further comprises said second set of data elements associated with said second time instance and a delay command indicating a duration between said first time instance and said second time instance.

7. The computing system of claim 6, wherein said first system sends packets specifying said recording to said second system,
wherein said second system upon receiving packets corresponding to said recording, first reproduces said drawing using said data elements, waits for said duration indicated by said delay command, and then reproduces said second drawing using said second set of elements,
whereby said second system reproduces on said peer board, the actions performed by a user on said source board.

8. The computing system of claim 7, wherein said first system further stores said recording according to a text format.

9. The computing system of claim 8, wherein said recording also comprises an audio generated at said time instance.

10. The computing system of claim 2, wherein said content comprises a drawing on said source board, said drawing being represented by a plurality of coordinates in the form of corresponding data elements,
wherein said first system performs a character recognition of said drawing to identify a set of characters, said set of characters being sent in said plurality of packets.

11. The computing system of claim 10, wherein said first system sends said plurality of coordinates also along with said set of characters in said plurality of packets.

12. The computing system of claim 11, wherein said plurality of coordinates are sent in compressed form of said corresponding data elements.

13. The computing system of claim 10, wherein said character recognition identifies that a first portion of said drawing represents a first character,
wherein said first system displays said first character associated with said first portion in said source board,
wherein said first system replaces said first portion with an image representing said first character if no cancel action is received in a pre-determined duration.

14. The computing system of claim 2, wherein said content comprises a pre-defined shape displayed on said source board,
wherein said first system sends in said plurality of packets an identifier specifying said pre-defined shape and attributes of said pre-defined shape, such that said second system can reproduce said pre-defined shape in said peer board.

15. The computing system of claim 14, wherein said pre-defined shape and attributes of said pre-defined shape are specified as user inputs,
wherein said first system forms and sends said identifier and said attributes in response to said user inputs.

16. The computing system of claim 15, wherein said pre-defined shape is one of a geometrical shape, a text and an image, wherein attributes of said geometrical shape comprises one or more dimensions of said geometrical shape, wherein attributes of said text comprises a font style, a font size, a text color, and a background color of said text, wherein attributes of said image comprises a location, a height, a width of said image.

17. The computing system of claim 2, wherein said content comprises a clip specified as user inputs, wherein said clip is in the form of an audio, video or a combination thereof,
wherein said first system sends in said plurality of packets an identifier specifying a type of said clip and attributes of said clip, such that said second system can reproduce said clip in said peer board.

18. The computing system of claim 2, wherein said content comprises multiple sub-contents in the form of a set of pages, wherein said source board and said peer board are designed to display only one of said set of pages, wherein said source board and said peer board are displaying a current page,
wherein said second system maintains the sub-content in each of said set of pages in a local storage,
wherein in response to said first system indicating that a previous page is to be displayed, said second systems retrieves a sub-content corresponding to said previous page from said local storage and provides said sub-content on said peer board,
wherein said second system reproduces said previous page without receiving packets corresponding to said sub-content from said first system.

19. The computing system of claim 2, wherein said first system receives an user input indicating that an action is to be performed on said source board,
wherein said first system sends in said plurality of packets an identifier specifying said action, such that said second system can reproduce said action in said peer board.

20. The computing system of claim 19, wherein said action comprises one of clearing said content displayed on said source board, undoing or redoing a previous action performed on said source board and recording a delay between user inputs provided on said source board.

21. A method of providing a shared electronic whiteboard, said method being performed in a first system, said method comprising:
providing, by a first browser executing in a first system, a source board of said shared electronic whiteboard; and
sending to a second system, a plurality of packets specifying a content of said source board, wherein each packet has a network destination address set to an IP address of said second system, said second system coupled to the first system over a network and said plurality of packets being sent on said network to said second system,
wherein said second system reproduces said content on a peer board of said shared electronic board in response to receiving said plurality of packets, said peer board being provided by a second browser executing in said second system.

22. A non-transitory machine readable medium storing one or more sequences of instructions for causing a first system to provide a peer board of a shared electronic whiteboard, wherein a source board of said shared electronic whiteboard is provided by a second browser executing in a second system, said one of more sequences of instructions comprising:
a first set of instructions, which when executed in said first system provides a first browser which displays a web page, and provides said peer board as a part of said web page; and
a second set of instructions, which when executed in the context of said first browser, performs the actions of:
obtaining an IP (Internet Protocol) address of said second system;
establishing, using said IP address, a communication channel with said second browser executing in said second system;
receiving a plurality of packets specifying a content of said source board; and
reproducing, in response to receiving said plurality of packets, said content in said target board.
